(19) United States
(12) Patent Application Publication
(10) Pub. No.: US 2023/0273656 A1
(43) Pub. Date: Aug. 31, 2023

(54) APPARATUSES WITH MOVABLE PANELS TO SUPPORT ELECTRONIC MODULES

(71) Applicant: Hewlett-Packard Development Company, L.P., Spring, TX (US)

(72) Inventor: Victor Su, Taipei City (TW)

(73) Assignee: Hewlett-Packard Development Company, L.P., Spring, TX (US)

(21) Appl. No.: 18/007,440

(22) PCT Filed: Jul. 31, 2020
(86) PCT No.: PCT/US2020/044618

§ 371 Date: Jan. 30, 2023

(51) Int. Cl. G06F 1/18

(52) U.S. Cl. CPC G06F 1/185; G06F 1/186; G06F 1/181

(57) ABSTRACT

According to examples, an apparatus may include side walls, a socket positioned between the side walls, and movable panels slidably mounted on the side walls, in which the movable panels are to support an electronic module. The apparatus may also include a handle connected to the movable panels, in which rotation of the handle in a first direction causes the movable panels to move laterally with respect to the side walls away from the socket and rotation of the handle in a second direction causes the movable panels to move laterally with respect to the side walls toward the socket to cause, when the electronic module is supported by the movable panels, the electronic module to be removed from or to be inserted into the socket.

### BACKGROUND

Computing devices, such as laptop computers and desktop computers, may include a removable module, such as a memory module. A user may remove a module that is currently installed in a computing device by disengaging the module from a socket and removing the disengaged module from the computing device. The user may also insert a new module into the socket. The user may replace the existing module with the new module in instances in which the existing module is faulty and/or the existing module is to be upgraded.

### BRIEF DESCRIPTION OF THE DRAWINGS

Features of the present disclosure are illustrated by way of example and not limited in the following figure(s), in which like numerals indicate like elements, in which:

FIGS. 1A and 1B, respectively, show block diagrams of an example apparatus that may include movable panels to support an electronic module during two stages of movement;

FIG. 1C shows a cross-sectional side view of a section of the example apparatus depicted in FIGS. 1A and 1B in which the first movable panel and the second movable panel may support the electronic module using mating structures;

FIG. 2 shows a perspective view of a portion of the example apparatus depicted in FIGS. 1A and 1B and an electronic module, in which structural features that may hold the electronic module in place with respect to the first movable panel and the second movable panel are shown;

FIG. 3 shows a perspective view of an example apparatus that may include first and second movable panels to support an electronic module; and

FIGS. 4A and 4B, respectively, show block diagrams of an example computing device that may include either of the example apparatuses depicted in FIGS. 1A and 3 discussed herein.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

In many computing devices, modules, such as small outline dual in-line memory modules (SO-DIMMs) may need to be placed at an angle and then inserted into a socket retention device. As the modules may be angled during insertion into and removal from the socket retention device, a relatively large amount of space above the socket retention device may be needed. In many instances, a cover of the computing device or other hardware component may prevent the adequate space from being available. As a result, the cover or other hardware component may need to be removed in order to remove or insert a module.

Disclosed herein are apparatuses that may enable the removal and/or insertion of modules without requiring that a cover or other hardware component positioned above a socket that is to receive the modules be removed. Particularly, the apparatuses disclosed herein may include laterally movable panels that may be slidably mounted on side walls of the apparatuses. The movable panels may support an electronic module such that the electronic module may move with movement of the movable panels such that the electronic module may be inserted into and disengaged from a socket through the lateral movement of the movable panels. In addition, the movable panels may include structural features that are retain the electronic module, in which the electronic module may be placed into engagement with the structural features through a vertical movement.

That is, for instance, the electronic module may be moved laterally above the apparatus disclosed herein and may be placed into engagement with the structural features by moving the electronic module downward onto the movable panels. Likewise, the electronic module may be removed from the movable panels by moving the electronic module vertically to disengage the electronic module from the structural features and then moved laterally away from the apparatus. As such, the electronic module may not be positioned at an angle during insertion or removal of the electronic module and may thus require less space above the apparatus as compared with conventional socket devices. Through implementation of the apparatuses disclosed herein, electronic modules, such as SO-DIMMs, may be inserted into and removed from computing devices without removing other components of the computing devices, which may simplify the replacement of such electronic modules.

Throughout the present disclosure, the terms “a” and “an” are intended to denote at least one of a particular element. As used herein, the term “includes” means includes but not limited to, the term “including” means including but not limited to. The term “based on” means based at least in part on.

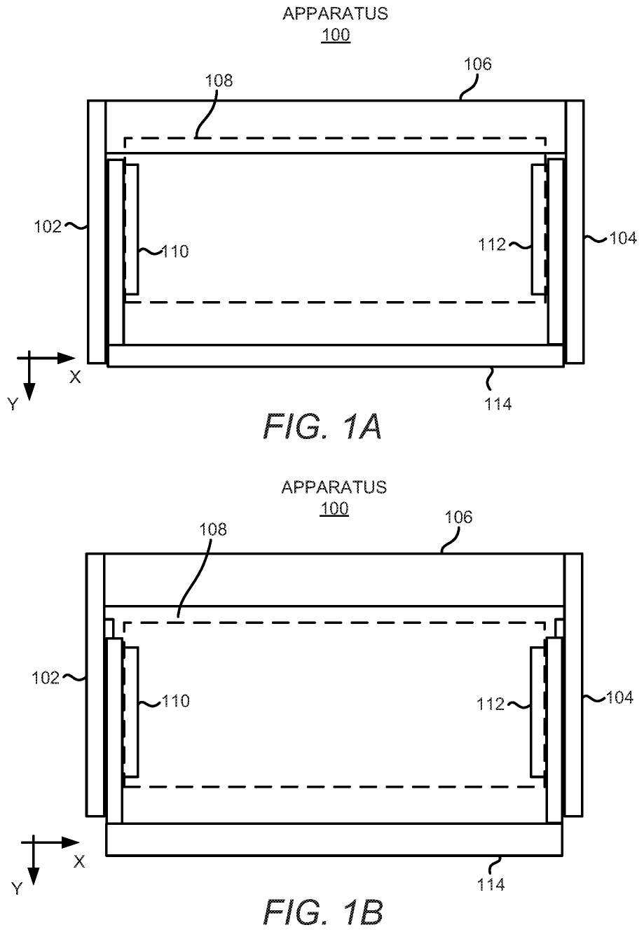

Reference is first made to FIGS. 1A and 1B, which respectively show block diagrams of an example apparatus 100 that may include movable panels to support an electronic module during two stages of movement. It should be understood that FIGS. 1A and 1B may include additional attributes and that some of the attributes described herein may be removed and/or modified without departing from the scopes of the features depicted in those figures.

The apparatus 100 may include a first side wall 102 and a second side wall 104. The apparatus 100 may also include a socket 106 that may be positioned between the first side wall 102 and the second side wall 104. As shown in FIGS. 1A and 1B, the socket 106 may be positioned at a back end of the apparatus 100 and in some examples, may be attached to the first side wall 102 and the second side wall 104. As discussed herein, the socket 106 may include electrical connectors (not shown) that may engage with and become electrically connected to electrical connectors in an electronic module 108 such that electrical signals may be communicated via the respective electrical connectors. The electrical connectors in the socket 106 may be connected to a motherboard or other hardware device in a computing device (not shown) within which the apparatus 100 may be housed such that the motherboard or other hardware device may communicate the electrical signals with the electronic module 108. The electronic module 108 is depicted with dashed lines to indicate that the electronic module 108 may not form part of the apparatus 100.

According to examples, the electronic module 108 may be any suitable type of module that may be inserted into and removed from the socket 106 and may communicate electrical signals with a motherboard or other hardware device in a computing device. By way of example, the electronic module 108 may be a memory module, such as a small outline dual in-line memory module (SO-DIMM). In other examples, the electronic module 108 may be another type of module, such as a different type of memory module, a wireless network card, or the like.

The apparatus 100 may also include a first movable panel 110 that may slidably be mounted on the first side wall 102 and a second movable panel 112 that may slidably be mounted on the second side wall 104. The first movable panel 110 may slidably be mounted on the first side wall 102 and the second movable panel 112 may slidably be mounted on the second side wall 104 in any suitable manner. As discussed herein, the first movable panel 110 and the second movable panel 112 may hold the electronic module 108 such that the electronic module 108 may move with the first movable panel 110 and the second movable panel 112.

FIG. 1C shows a cross-sectional side view of a section of the example apparatus 100 in which the first movable panel 110 and the second movable panel 112 may support the electronic module 108. Particularly, FIG. 1C shows that the first side wall 102 may include a first mating structure 120 and that the first movable panel 110 may include a second mating structure 122. The second side wall 104 and the second movable panel 112 may each include similar mating structures 120, 122. The first mating structure 120 and the second mating structure 122 may include mating channels that may enable the first movable panel 110 and the second movable panel 112 to slidably move with respect to the first side wall 102 and the second side wall 104.

Although FIG. 1C shows a particular type of mating structures 120, 122, it should be understood that other types of mating structures may instead be used to enable the first movable panel 110 and the second movable panel 112 to have a sliding relationship with the first side wall 102 and the second side wall 104. For instance, the first mating structure 120 and the second mating structure 122 may include horizontal surfaces in which the second mating structure 122 rests on top of the first mating structure 120. As another example, one of the first mating structure 120 and the second mating structure 122 may include a horizontal surface and the other one of the first mating structure 120 and the second mating structure 122 may include wheels or bearings that may travel on the horizontal surface.

The first movable panel 110 and the second movable panel 112 may also support a second electronic module 124. The first movable panel 110 and the second movable panel 112 may support the second electronic module 124 in manners similar to those discussed herein with respect to the electronic module 108. In addition, the socket 106 may include a slot into which the second electronic module 124 may be inserted. The slot may include electrical connectors to which electrical connectors on the second electronic module 124 may be connected similarly to the electrical connectors that may be connected to the electronic module 108.

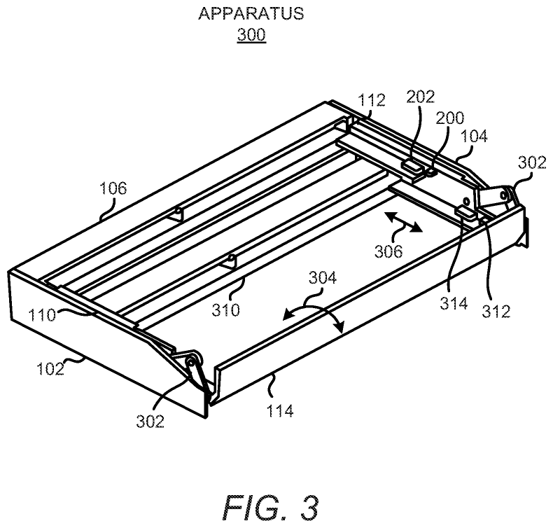

The apparatus 100 may also include a handle 114 that is connected to the first movable panel 110 and the second movable panel 112. The handle 114 may be rotatable about an axis (the X-axis shown in FIG. 1A), for instance, along a lower section of the handle 114. The handle 114 may be connected to the first movable panel 110 and the second movable panel 112 in a manner in which rotation of the handle 114 in a first direction causes the first movable panel 110 and the second movable panel 112 to move laterally with respect to the first side wall 102 and the second side wall 104 away from the socket 106. That is, rotation of the handle 114 in the Y-axis away from the socket 106 may cause the first movable panel 110 and the second movable panel 112 to move laterally away from the socket 106 as shown in FIG. 1B. An example of a configuration that may enable this type of relative movement is described with respect to FIG. 3 below.

As shown in FIG. 1B, the lateral movement of the first movable panel 110 and the second movable panel 112 away from the socket 106 may cause the electronic module 108 to be removed or disengaged from the socket 106. Following removal of the electronic module 108 from the socket, the electronic module 108 may be disengaged from the first movable panel 110 and the second movable panel 112. The electronic module 108 also be removed from the apparatus 100 and a new electronic module 108 may be placed into engagement with the first movable panel 110 and the second movable panel 112. In addition, the handle 114 may be rotated toward the socket 106, which may cause the first movable panel 110 and the second movable panel 112 and the new electronic module 108 to be moved laterally toward the socket 106. The new electronic module 108 may thus be inserted into the socket 106 as shown in FIG. 1A.

According to examples, in addition to being rotatable, the handle 114 may also be moved laterally with respect to the socket 106. The lateral movement of the handle 114 may enable larger lateral movements of the first movable panel 110 and the second movable panel 112. That is, the lateral movement of the handle 114 may also cause the first movable panel 110 and the second movable panel 112 to move further laterally with respect to the first side wall 102 and the second side wall 104.

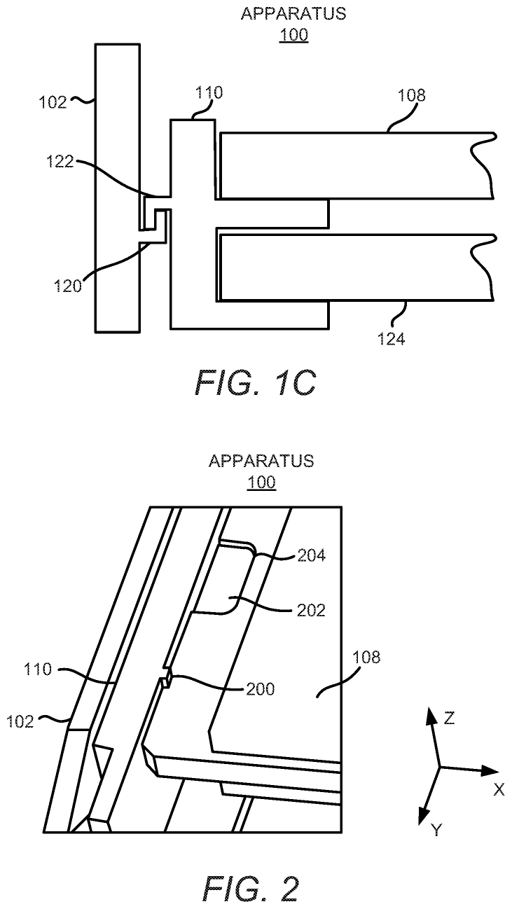

Turning now to FIG. 2, there is shown a perspective view of a portion of the example apparatus 100 and the electronic module 108. As shown, the first movable panel 110 may include structural features 200, 202 that may hold the electronic module 108 in place with respect to the first movable panel 110 and the second movable panel 112. Particularly, the structural features 200, 202 may hold the electronic module 108 in place in each of the horizontal (X), lateral (Y), and vertical (Z) dimensions. That is, a first structural feature 200 may include a relatively small protrusion that may engage a top surface of the electronic module 108 and may thus restrict movement of the electronic module 108 in the Z direction. However, as the first structural feature 200 may be relatively small, the electronic module 108 may be moved in the Z direction through application of a relatively small amount of force in the Z direction. For instance, application of the relatively small amount of force in the Z direction may cause either or both of the first structural feature 200 and the electronic module 108 to flex slightly and thus release the electronic module 108 from engagement with the first structural feature 200. As discussed herein, the electronic module 108 may be moved in the Z direction during removal from or insertion into the apparatus 100.

A second structural feature 202 may include a protrusion that may extend toward the electronic module 108. The electronic module 108 may also include a mating slot 204 into which the second structural feature 202 may be inserted. Particularly, the second structural feature 202 may be inserted into the mating slot 204 through movement of the electronic module 108 vertically, e.g., in the negative Z direction. Similarly, the second structural feature 202 may be removed from the mating slot 204 through movement of the electronic module 108 in the positive Z direction. As shown, the second structural feature 202 may have a height (in the Z direction) that is relatively lower than the height of the mating slot 204 and thus, the distance that the electronic module 108 may be moved vertically before the electronic module 108 may be moved laterally, e.g., in the Y direction, e.g., to clear the second structural feature 202, may be relatively small.

Although not shown, the second movable panel 112 may include similar structural features 200, 202 and the electronic module 108 may include a similar slot 204 on the opposite side of the electronic module 108. As such, the first movable panel 110 and the second movable panel 112 may hold both sides of the electronic module 108. The movement of the first movable panel 110 and the second movable panel 112 may thus cause the electronic module 108 to also be inserted into or removed from the socket 106.

Turning now to FIG. 3, there is shown a perspective view of an example apparatus 300 that may include first and second movable panels 110, 112 to support an electronic module 108. It should be understood that FIG. 3 may include additional attributes and that some of the attributes described herein may be removed and/or modified without departing from the scopes of the attributes depicted in that figure.

The apparatus 300 may be equivalent to the apparatus 100 and thus both of the apparatuses 100, 300 may include common features. As shown, the apparatus 300 may include the first and second side walls 102, 104, the socket 106, the first and second movable panels 110, 112, and the handle 114. The first and second side walls 102, 104 may also respectively include the first and second structural features 200, 202.

As shown in FIG. 3, the apparatus 300 may include linkages 302 that may connect the first and second movable panels 110, 112 to the handle 114. The linkages 302 may translate rotational movement of the handle 114, as represented by the arrows 304, to the lateral movement of the first and second movable panels 110, 112, as represented by the arrows 306. That is, rotation of the handle 114 in a first direction away from the socket 106 may cause the first and second movable panels 110, 112 to move away from the socket 106. Likewise, rotation of the handle 114 in a second direction toward the socket 106 may cause the first and second movable panels 110, 112 to move toward the socket 106.

The linkages 302 may be sized and arranged to enable, when the handle 114 is rotated, the first and second movable panels 110, 112 to move a sufficient distance to cause an electronic module 108 to be inserted into and removed from the socket 106 while the electronic module 108 may be removed from the first and second panels 110, 112 when the electronic module 108 is disengaged from the socket 106. In some examples, the handle 114 may also be laterally movable with respect to the first and second side walls 102, 104 to cause the first and second movable panels 110, 112 to traverse a larger distance.

As also shown in FIG. 3, the apparatus 300 may include a second socket 310 positioned between the first and second side walls 102, 104. The second socket 310 may be positioned below the socket 106 and may, in some examples, be attached to the first and second side walls 102, 104. The second socket 310 may also be offset from the socket 106, e.g., the second socket 310 may be positioned to be closer to the handle 114. The first and second movable panels 110, 112 may support a second electronic module (not shown) at a location that is below the electronic module 108. In addition, rotation of the handle 114 in the first direction is to cause, when the second electronic module is supported by the first and second movable panels 110, 112, the second electronic module to be inserted into or disengaged from the second socket 310.

The first and second movable panels 110, 112 may include additional structural features 312, 314 to hold the second electronic module 124 in each of the horizontal (X direction), vertical (Z direction), and lateral (Y direction) dimensions and at a certain height below the electronic module 108. The additional structural features 312, 314 may respectively be equivalent to the first and second structural features 200, 202.

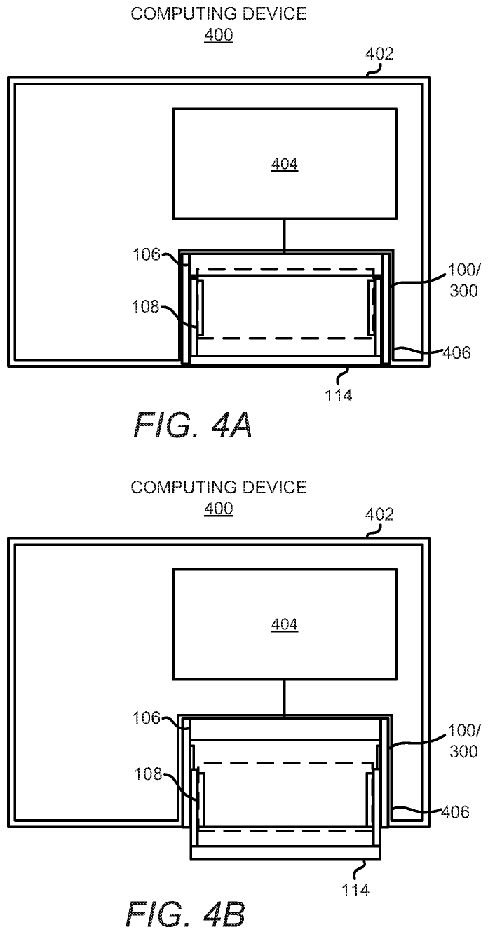

Turning now to FIGS. 4A and 4B, there are respectively shown block diagrams of an example computing device 400 that may include either of the example apparatuses 100 or 300 discussed herein. It should be understood that FIGS. 4A and 4B may include additional attributes and that some of the attributes described herein may be removed and/or modified without departing from the scopes of the features depicted in those figures.

As shown in FIGS. 4A and 4B, in addition to the apparatus 100/300, the computing device 400 may include a casing 402 and a motherboard 404 among other components. Generally speaking, the computing device 400 may be any suitable type of computing device within which the apparatus 100/300 may be housed. For instance, the computing device 400 may be a laptop computer, a desktop computer, a smartphone, a tablet computer, and/or the like. The socket 106 may be connected to the motherboard 404 such that components on the motherboard 404 may communicate with an electronic module 108 inserted into the socket 106.

In some examples, the computing device 400 may include a slot 406 into which the apparatus 100/300 may be inserted. The slot 406 may include an opening on a side of the casing 402 through which the handle 114 may be accessible. For instance, the handle 114 may cover the opening of the slot 406 and may thus form a part of the casing 402. In any regard, and as shown in FIG. 1B, the handle 114 may be rotated away from the socket 106, which may cause the first and second movable panels 110, 112 to be moved laterally away from the socket 106. As a result, an electronic module 108 be disengaged from the socket 106 and may be accessible through the opening in the slot 406. In some examples, the handle 114 may also be movable laterally to increase the distance that the electronic module 108 may be moved away from the casing 402 to better enable the electronic module 108 to be accessible.

The first and second movable panels 110, 112 may position the electronic module 108 sufficiently below a top of the casing 402 to enable the electronic module 108 to be moved vertically to disengage from the first and second structural features 200, 202 when the handle 114 is moved away from the casing 402. Likewise, there may be sufficient space between the first and second movable panels 110, 112 and the top of the casing 402 to enable the electronic module 108 to be moved vertically to engage the first and second structural features 200, 202 while the handle 114 is moved away from the casing 402. Following insertion of the electronic module 108 onto the first and second movable panels 110, 112, the handle 114 may be moved toward the socket 106 and the electronic module 108 may be inserted into the socket 106.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
side walls;
a socket positioned between the side walls;
movable panels slidably mounted on the side walls, wherein the movable panels are to support an electronic module; and
a handle connected to the movable panels, wherein rotation of the handle in a first direction causes the movable panels to move laterally with respect to the side walls away from the socket and rotation of the handle in a second direction causes the movable panels to move laterally with respect to the side walls toward the socket to cause, when the electronic module is supported by the movable panels, the electronic module to be removed from or to be inserted into the socket.

2. The apparatus of claim 1, further comprising:
linkages connecting the movable panels to the handle, wherein the linkages translate rotational movement of the handle to the lateral movement of the movable panels.

3. The apparatus of claim 1, wherein the movable panels include structural features to hold the electronic module in place with respect to the movable panels.

4. The apparatus of claim 3, wherein the structural features are to hold the electronic module in each of the horizontal, vertical, and lateral dimensions.

5. The apparatus of claim 1, further comprising:
a second socket positioned between the side walls, the second socket being positioned below the socket;
wherein the movable panels are to support a second electronic module; and
wherein rotation of the handle in the first direction is to cause, when the second electronic module is supported by the movable panels, the second electronic module to be inserted into or disengaged from the second socket.

6. The apparatus of claim 5, further comprising:
additional structural features to hold the second electronic module in each of the horizontal, vertical, and lateral dimensions and at a certain height below the electronic module.

7. The apparatus of claim 1, wherein the handle is laterally movable with respect to the side walls.

8. A computing device comprising:
a casing; and
an apparatus positioned inside the casing, the apparatus including:
a first side wall and a second side wall;
a socket attached to the first side wall and the second side wall;
a first movable panel slidably mounted on the first side wall;
a second movable panel slidably mounted on the second side wall; and
a handle connected to the first movable panel and the second movable panel, wherein rotation of the handle in a first direction causes the first and second movable panels to move laterally with respect to the first and second side walls away from the socket and rotation of the handle in a second direction causes the first and second movable panels to move laterally with respect to the first and second side walls toward the socket to cause, when an electronic module is supported by the first and second movable panels, the electronic module to be inserted into or removed from the socket.

9. The computing device of claim 8, wherein the casing includes a slot at an exterior of the casing and wherein the apparatus is inserted in the slot and the handle is accessible from the exterior of the casing.

10. The computing device of claim 9, wherein the apparatus further comprises:
linkages connecting the first and second movable panels to the handle, wherein the linkages translate rotational movement of the handle to the lateral movement of the first and second movable panels.

11. The computing device of claim 9, wherein the apparatus further comprises:
structural features to removably support the electronic module from moving with respect to the first and second movable panels when the electronic module is supported by the first and second movable panels.

12. The computing device of claim 9, wherein the apparatus further comprises:
a second socket attached to the first and second side walls, the second socket being positioned above the socket;
wherein the first and second movable panels are to support a second electronic module; and
wherein rotation of the handle in the first direction is to cause, when the second electronic module is supported by the movable panels, the second electronic module to be inserted into or removed disengage from the second socket.

13. The computing device of claim 9, wherein the handle is laterally movable with respect to the first and second side walls.

14. An apparatus comprising:
a first side wall;
a second side wall;
a first movable panel slidably mounted on the first side wall;
a second movable panel slidably mounted on the second side wall; and
a handle connected to the first movable panel and the second movable panel, wherein:
rotation of the handle in a first direction causes the first and second movable panels to move laterally with respect to the first and second side walls away from a socket to cause, when an electronic module is supported by the first and second movable panels, the electronic module to be removed from the socket, and
rotation of the handle in a second direction causes the first and second movable panels to move laterally with respect to the first and second side walls toward the socket to cause, when the electronic module is supported by the first and second movable panels, the electronic module to be inserted into the socket.

15. The apparatus of claim 14, further comprising:
linkages connecting the first and second movable panels to the handle, wherein the linkages translate rotational movement of the handle to lateral movement of the first and second movable panels.
